(19) United States
(12) Patent Application Publication
(10) Pub. No.: US 2023/0284292 A1
(43) Pub. Date: Sep. 7, 2023

(54) NETWORK REPOSITORY FUNCTION REGISTRATION

(71) Applicant: Nokia Technologies Oy, Espoo (FI)

(72) Inventors: Vesa Pauli HELLGREN, Helsinki (FI); loannis MOUROULIS, Athens (GR); Bruno LANDAIS, Pleumeur-Bodou (FR); Saurabh KHARE, Bangalore (IN)

(21) Appl. No.: 18/006,919

(22) PCT Filed: Jul. 12, 2021
(86) PCT No.: PCT/EP2021/069326

§ 371 Date: Jan. 26, 2023

(30) Foreign Application Priority Data
Aug. 7, 2020 (IN) 202041033958

(51) Int. Cl. H04W 76/10; H04W 72/232; H04W 72/1273

(52) U.S. Cl. CPC H04W 76/10; H04W 72/232; H04W 72/1273

(57) ABSTRACT

There is provided a network apparatus, caused to: maintain a registration of at least one Network Repository Function (NRF) with respective associated information for selecting the at least one NRF; and, in response to a request for NRF information from a requesting network entity, provide the associated information to the requesting network entity.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node, and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G radio or new radio (NR) access technology.

### SUMMARY

According to a first aspect, there is provided a network apparatus, comprising: means for maintaining a registration of at least one Network Repository Function (NRF) with respective associated information for selecting the at least one NRF; and means for, in response to a request for NRF information from a requesting network entity, providing the associated information to the requesting network entity.

The network apparatus may comprise means for receiving a registration request from the at least one NRF, the registration request comprising the associated information.

The request for NRF information may be a Discovery request, and the apparatus may comprise means for selecting a subset of the total associated information maintained at the network apparatus and means for providing the subset of the total associated information in said response.

Said request for NRF information may be a subscription request, and said response may be sent when there is change in said registration of the at least one NRF.

The network apparatus may be comprised within an NRF.

The network apparatus may comprise means for providing the associated information to other NRFs.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a second aspect, there is provided a network apparatus for a Network Repository Function (NRF), comprising: means for transmitting a registration request to a registering network entity, wherein the registration request comprises associated information for selecting the NRF.

The network apparatus may comprise means for transmitting a discovery request to the registering network entity for selection information for selecting at least one other NRF; and means for receiving said selection information in response to the discovery request.

The network apparatus may comprise means for transmitting a subscription request to the registering network entity for subscribing to being notified when selection information for selecting at least one other NRF changes at the registering network entity; and means for receiving a notification that said selection information has changed in response to the subscription request.

The network apparatus may form an NRF group with at least one other NRF apparatus, and comprise: means for receiving selection information for selecting said at least one other NRF; means for determining that said at least one other NRF is part of the same NRF group; and means for exchanging information about network function instances served by the at least one other NRF and the network apparatus in response to said determining.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a third aspect, there is provided a network apparatus comprising: means for transmitting a request to a registering network entity for selection information for selecting at least one Network Repository Function (NRF); and means for receiving said selection information in response to the request.

The request may be a discovery request.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a fourth aspect, there is provided a method for a network apparatus, the method comprising: maintaining a registration of at least one Network Repository Function (NRF) with respective associated information for selecting the at least one NRF; and, in response to a request for NRF information from a requesting network entity, providing the associated information to the requesting network entity.

The method may comprise receiving a registration request from the at least one NRF, the registration request comprising the associated information.

The request for NRF information may be a Discovery request, and the method may comprise selecting a subset of the total associated information maintained at the network apparatus and providing the subset of the total associated information in said response.

Said request for NRF information may be a subscription request, and said response may be sent when there is change in said registration of the at least one NRF.

The network apparatus may be comprised within an NRF.

The method may comprise providing the associated information to other NRFs.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a fifth aspect, there is provided a method for a network apparatus for a Network Repository Function (NRF), the method comprising: transmitting a registration request to a registering network entity, wherein the registration request comprises associated information for selecting the NRF.

The method may comprise transmitting a discovery request to the registering network entity for selection information for selecting at least one other NRF; and receiving said selection information in response to the discovery request.

The method may comprise transmitting a subscription request to the registering network entity for subscribing to being notified when selection information for selecting at least one other NRF changes at the registering network entity; and receiving a notification that said selection information has changed in response to the subscription request.

The network apparatus may form an NRF group with at least one other NRF apparatus, and the method may comprise: receiving selection information for selecting said at least one other NRF; determining that said at least one other NRF is part of the same NRF group; and exchanging information about network function instances served by the at least one other NRF and the network apparatus in response to said determining.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a sixth aspect, there is provided a method for a network apparatus, the method comprising: transmitting a request to a registering network entity for selection information for selecting at least one Network Repository Function (NRF); and receiving said selection information in response to the request.

The request may be a discovery request.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a seventh aspect, there is provided a network apparatus comprising at least one processor and at least one memory comprising code that, when executed by the at least one processor, causes the network apparatus to: maintain a registration of at least one Network Repository Function (NRF) with respective associated information for selecting the at least one NRF; and, in response to a request for NRF information from a requesting network entity, provide the associated information to the requesting network entity.

The network apparatus may be caused to receive a registration request from the at least one NRF, the registration request comprising the associated information.

The request for NRF information may be a Discovery request, and the network apparatus may be caused to select a subset of the total associated information maintained at the network apparatus and provide the subset of the total associated information in said response.

Said request for NRF information may be a subscription request, and said response may be sent when there is change in said registration of the at least one NRF.

The network apparatus may be comprised within an NRF.

The network apparatus may be caused to provide the associated information to other NRFs.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to an eighth aspect, there is provided a network apparatus for a Network Repository Function (NRF), the network apparatus comprising at least one processor and at least one memory comprising code that, when executed by the at least one processor, causes the network apparatus to: transmit a registration request to a registering network entity, wherein the registration request comprises associated information for selecting the NRF.

The network apparatus may be caused to transmit a discovery request to the registering network entity for selection information for selecting at least one other NRF; and receive said selection information in response to the discovery request.

The network apparatus may be caused to transmit a subscription request to the registering network entity for subscribing to being notified when selection information for selecting at least one other NRF changes at the registering network entity; and receive a notification that said selection information has changed in response to the subscription request.

The network apparatus may form an NRF group with at least one other NRF apparatus, and the method may comprise: receiving selection information for selecting said at least one other NRF; determining that said at least one other NRF is part of the same NRF group; and exchanging information about network function instances served by the at least one other NRF and the network apparatus in response to said determining.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a ninth aspect, there is provided a network apparatus comprising at least one processor and at least one memory comprising code that, when executed by the at least one processor, causes the network apparatus to: transmit a request to a registering network entity for selection information for selecting at least one Network Repository Function (NRF); and receive said selection information in response to the request.

The request may be a discovery request.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a tenth aspect, there is provided non-transitory computer readable medium comprising program instructions for causing a network apparatus to perform at least the following: maintain a registration of at least one Network Repository Function (NRF) with respective associated information for selecting the at least one NRF; and, in response to a request for NRF information from a requesting network entity, provide the associated information to the requesting network entity.

The network apparatus may be caused to receive a registration request from the at least one NRF, the registration request comprising the associated information.

The request for NRF information may be a Discovery request, and the network apparatus may be caused to select a subset of the total associated information maintained at the network apparatus and provide the subset of the total associated information in said response.

Said request for NRF information may be a subscription request, and said response may be sent when there is change in said registration of the at least one NRF.

The network apparatus may be comprised within an NRF.

The network apparatus may be caused to provide the associated information to other NRFs.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to an eleventh aspect, there is provided non-transitory computer readable medium comprising program instructions for causing a network apparatus for a Network Repository Function (NRF) to perform at least the following: transmit a registration request to a registering network entity, wherein the registration request comprises associated information for selecting the NRF.

The network apparatus may be caused to transmit a discovery request to the registering network entity for selection information for selecting at least one other NRF; and receive said selection information in response to the discovery request.

The network apparatus may be caused to transmit a subscription request to the registering network entity for subscribing to being notified when selection information for selecting at least one other NRF changes at the registering network entity; and receive a notification that said selection information has changed in response to the subscription request.

The network apparatus may form an NRF group with at least one other NRF apparatus, and the method may comprise: receiving selection information for selecting said at least one other NRF; determining that said at least one other NRF is part of the same NRF group; and exchanging information about network function instances served by the at least one other NRF and the network apparatus in response to said determining.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a twelfth aspect, there is provided non-transitory computer readable medium comprising program instructions for causing a network apparatus to perform at least the following: transmit a request to a registering network entity for selection information for selecting at least one Network Repository Function (NRF); and receive said selection information in response to the request.

The request may be a discovery request.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a thirteenth aspect, there is provided a network apparatus, comprising: maintaining circuitry for maintaining a registration of at least one Network Repository Function (NRF) with respective associated information for selecting the at least one NRF; and providing circuitry for, in response to a request for NRF information from a requesting network entity, providing the associated information to the requesting network entity.

The network apparatus may comprise receiving circuitry for receiving a registration request from the at least one NRF, the registration request comprising the associated information.

The request for NRF information may be a Discovery request, and the apparatus may comprise selecting circuitry for selecting a subset of the total associated information maintained at the network apparatus and providing circuitry for providing the subset of the total associated information in said response.

Said request for NRF information may be a subscription request, and said response may be sent when there is change in said registration of the at least one NRF.

The network apparatus may be comprised within an NRF.

The network apparatus may comprise providing circuitry for providing the associated information to other NRFs.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a fourteenth aspect, there is provided a network apparatus for a Network Repository Function (NRF), comprising: transmitting circuitry for transmitting a registration request to a registering network entity, wherein the registration request comprises associated information for selecting the NRF.

The network apparatus may comprise transmitting circuitry for transmitting a discovery request to the registering network entity for selection information for selecting at least one other NRF; and receiving circuitry for receiving said selection information in response to the discovery request.

The network apparatus may comprise transmitting circuitry for transmitting a subscription request to the registering network entity for subscribing to being notified when selection information for selecting at least one other NRF changes at the registering network entity; and receiving circuitry for receiving a notification that said selection information has changed in response to the subscription request.

The network apparatus may form an NRF group with at least one other NRF apparatus, and comprise: receiving circuitry for receiving selection information for selecting said at least one other NRF; determining circuitry for determining that said at least one other NRF is part of the same NRF group; and exchanging circuitry for exchanging information about network function instances served by the at least one other NRF and the network apparatus in response to said determining.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a fifteenth aspect, there is provided a network apparatus comprising: transmitting circuitry for transmitting a request to a registering network entity for selection information for selecting at least one Network Repository Function (NRF); and receiving circuitry for receiving said selection information in response to the request.

The request may be a discovery request.

The associated information for a particular NRF may describe the attributes of at least one network function that said particular NRF is intended to serve.

The associated information may comprise at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

The associated information may comprise an identity of an NRF group that is served by the NRF associated with the associated information.

According to a sixteenth aspect, there is provided a computer program comprising program instructions for causing a computer to perform any method as described above.

According to a seventeenth aspect, there is provided a computer program product stored on a medium may cause an apparatus to perform any method as described herein.

According to an eighteenth aspect, there is provided an electronic device that may comprise apparatus as described herein.

According to a fourteenth aspect, there is provided a chipset that may comprise an apparatus as described herein.

Various other aspects are also described in the following detailed description and in the attached claims.

### BRIEF DESCRIPTION OF FIGURES

Embodiments will now be described, by way of example only, with reference to the accompanying Figures in which:

FIG. 1 shows a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some embodiments;

FIG. 5 shows illustrates signalling an entity located within a network repository function;

FIGS. 6A to 6C flow charts illustrating potential operations by apparatuses; and

FIGS. 7 to 10B illustrate example signalling operations between various network entities.

### DETAILED DESCRIPTION

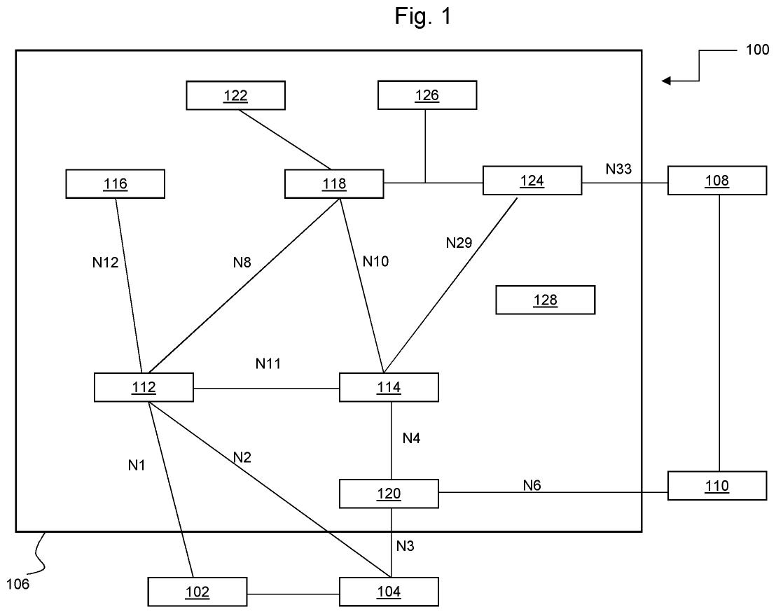

In the following certain embodiments are explained with reference to mobile communication devices capable of communication via a wireless cellular system and mobile communication systems serving such mobile communication devices. Before explaining in detail the exemplifying embodiments, certain general principles of a 5G wireless communication system are briefly explained with reference to FIG. 1.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) centralized unit functions. The RAN may comprise one or more access nodes.

The 5GC 106 may comprise one or more access management functions (AMF) 112, one or more session management functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The 5GC (5G Core network) has been defined as a Service Based Architecture (SBA). Service-Based Architectures provide a modular framework from which common applications can be deployed using components of varying sources and suppliers. Control plane functionality and common data repositories of a 5G network may thus be delivered by way of a set of interconnected Network Functions (NFs), each with authorization to access each other's services with Network Function (NF) service producers exposing services to NF service consumers. NFs may act as service consumers and/or service providers. NF service providers register their NF profile in a Network Repository Function (NRF). An NRF maintains an updated repository of 5G elements available in the operator's network, along with the services provided by each of the elements in the 5G core that are expected to be instantiated, scaled and/or terminated without or minimal manual intervention. In other words, the NRF maintains a record of available NF instances and their supported services. The NRF allows other NF instances to subscribe and be notified of registrations from NF instances of a given type. The NRF may support service discovery, by receipt of Discovery Requests from NF instances and details which NF instances support specific services. Therefore NF Service consumers or Service Communication Proxies (SCP) (which obtain NF services on behalf of another network entity) may discover NF service producers by performing for example, an NF Discovery procedure towards the NRF.

While 3GPP has standardized how to discover NF services, there are no standardised procedures on how NRFs are discovered and selected by NRF consumer NFs.

Currently, NRFs are locally preconfigured in each NF and the NRF selection logic is NF implementation specific. The only scenario in which an NRF is externally discoverable by an NF is when NRF discovery is performed from an AMF via a Network Slice Selection Function (NSSF) for SMF/AMF selection for a specific slice. A network slice may be through of as a virtualised network that uses the same physical hardware as other network slices for difference purposes. Network slicing separates the control plane (CP) from the user plane to move user plane functionality towards the network edge. One Application Programming Interface (API) for externally discovering an NRF is labelled as Nnssf_NSSelection in 3GPP TS 29.531.

In 3GPP Rel-16, a new service was added to the NRF Application Programming Interface called NNRF_Bootstrapping (currently defined in, for example, TS 29.510). This new service may be used as an entry point to discover other Service API URIs of a locally provisioned NRF. This Bootstrapping interface was designed to allow NF Service Consumers of an NRF know about the services endpoints it supports, by using a version-independent Uniform Resource Indicator (URI) endpoint that does not need to be discovered by using a dedicated Discovery service. 3GPP TS 29.510 also defined a NrfInfo Profile Information Element. The NrfInfo Profile Information Element comprises information of NF Instances that are currently registered to the NRF, but does not comprise information of the NRF itself.

As NRF selection is currently locally provisioned with non-standardised selection logic, a variety of issues may arise.

For example, as traffic distribution is static and relies on traffic projections/predictions that may be inaccurate or fluctuate based on events or time, there may be a suboptimal load distribution across the network. This is because there is no consistent way to actively load balance among multiple NRFs based on their load.

Further, there is no standard way for an NRF consumer to select NRF and route NF Discovery based on criterions (e.g. the full range of types of NF supportable/served by a particular NRF, Fully Qualified Domain Name (FQDN), locality in the network, etc.). This means that there is poor NRF selection control amongst the different NFs.

Further, as new NRFs need to be manually provisioned in NFs by the Operations and Management Function before they can be used, issues may arise with respect to the delay and resources that this manual NRF addition uses. Similar considerations apply in respect of the removal of an NRF provisioned in an NF.

Finally, as there is no standard way to acquire and monitor the capacity of NRF or the capacity of the NRF Service instances in the URIs acquired via the Bootstrap API, issues arise with respect to NRF sizing as there is no standard way to load balance traffics to NRFs in proportion to their capacity.

As discussed above, the NNRF_Bootstrapping Service API introduced in Rel-16 provides information of the services supported by an NRF but lacks important information such as capacity and criteria when to select a specific NRF. For example, DNS Service Record (SRV) Queries (SRV being defined in RFC 2782) could be used to provide priority and weights regarding NRFs. However, these SRV queries do not support NRF selection criteria. Also, as mentioned above, an AMF may discover an NRF via a network slice service function when selecting an AMF and/or an SMF. However this selection is dependent on network slicing.

The following aims to address at least one of the above-mentioned issues.

In general, there is provided a registration entity located in the core network with which other NRFs register along with information that is usable for selecting a particular NRF for supporting an NF service. This registration entity may be located in an NRF (hereinafter called an “NRF registrar”). The registration entity may be used by other entities (such as NRFs and NRF consumers) to discover NRF that are usable for supporting an NF service. For this discovery purpose, the registration entity may comprise a variety of information about each registered NRF. For example, the registration entity may comprise an indication of other NRFs profiles and services, without providing information on NF instances registered in these NRFs. It is understood that the type and/or amount of information stored about each registered NRF may vary between the registered NRFs. It is further understood that although the following refers to discovery and discovery procedures, that this includes the use of bootstrapping using a version-independent Uniform Resource Indicator (URI) endpoint that does not need to be discovered by using a dedicated Discovery service, as mentioned above.

The registered information and the stored information at the registration entity may comprise an information element. For clarity and ease of reference throughout the following, this information element is sometimes labelled as NRFSelectionInfo, although it is understood that this is simply a label for the present description and that any label may be used. This NRFSelectionInfo information element may describe the attributes of NFs that a particular NRF is intended to serve. Example criterions include: an indication of at least one type of network function for which discovery queries are supported by the NRF associated with the associated information, an identification of at least one network slice served the NRF associated with the associated information, an identification of at least Public Land Mobile Network supported by the NRF associated with the associated information, an identification of at least one Fully Qualified Domain Name that may be served by the NRF associated with the associated information, and/or an identity of an NRF group that is served by the NRF associated with the associated information. This is also illustrated later in respect of Table 1. It is understood that this list is neither limiting nor exhaustive.

The NRF Profiles stored in the registration entity may also comprise a list of NFServices provided by the NRF corresponding to a particular NRF profile. This list may comprise information such as NF priority and capacity. However, the NRF registrar may choose to not store information about the actual NF Instances currently registered in an NRF.

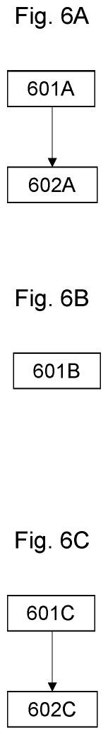

FIGS. 6A to 6C are flowcharts illustrating some general operations that may be performed according to the currently discussed mechanisms.

FIG. 6A is a flow chart illustrating potential actions of a network apparatus that acts as a register of NRFs in a system. For example, the network apparatus may be an NRF, such as an NRF registrar. An NRF registrar differs from a regular NRF in that it also comprises registration functionalities.

At 601A, the network apparatus maintains a registration of at least one Network Repository Function (NRF) with respective associated information for selecting the at least one NRF. This maintaining may be performed subsequent to receipt of a registration request from the at least one NRF. The registration request for a particular NRF may comprise the associated information for that NRF.

The associated information for a particular NRF may describe the attributes of at least one network function that said particular NRF is intended to serve. For example, the associated information may be at least one of: an indication of at least one type of network function for which discovery queries are supported by the NRF associated with the associated information, an identification of at least one network slice served the NRF associated with the associated information, an identification of at least Public Land Mobile Network supported by the NRF associated with the associated information, an identification of at least one Fully Qualified Domain Name that may be served by the NRF associated with the associated information, and/or an identity of an NRF group that is served by the NRF associated with the associated information.

At 602A, the network apparatus, in response to a request for NRF information from a requesting network entity, provides the associated information to the requesting network entity. The provision may be in response to receipt of a request for NRF information from the requesting network entity.

The request for NRF information may be a discovery request. In this case, the apparatus may select a subset of the total associated information maintained at the network apparatus and provide the subset of the total associated information in said response. In the present instance, it is understood that the term “subset” may refer to less than all of the associated information maintained by the network apparatus. The subset may be selected in dependence on a selection criteria comprised within the discovery request and/or based on a quality of the requesting network entity (which may be an NRF and/or an NRF consumer). For example, the subset may be selected in dependence on a locality of the requesting network entity to minimise signalling across the network.

The request for NRF information may be a subscription request. When the subscription request is a subscription request to be notified of changes in the associated information and/or register maintained by the network apparatus, the message sent at 602A providing associated information may be delayed until there is change in said registration of the at least one NRF. The associated information may be provided in a notification sent using, for example, a HTTP Notification message, such as the Subscribe/Notify communication described in Section 4.6.2 of 3GPP TS 29.501. Although it is understood that other types of messaging protocols may be used, depending on the communication network configuration. Prior to sending the notification, the network apparatus may immediately respond to the request for NRF information to acknowledge receipt of the subscription request and to indicate when a successful subscription has been set up.

FIG. 6B is a flow chart illustrating operations that may be performed by a Network Repository Function (NRF) interacting with the network apparatus/registering network entity of FIG. 6A.

At 601B, the NRF transmits a registration request to a registering network entity, wherein the registration request comprises associated information for selecting the NRF.

The associated information may describe the attributes of at least one network function that said NRF is intended to serve. For example, the associated information may be at least one of: an indication of at least one type of network function for which discovery queries are supported by the NRF associated with the associated information, an identification of at least one network slice served the NRF associated with the associated information, an identification of at least Public Land Mobile Network supported by the NRF associated with the associated information, an identification of at least one Fully Qualified Domain Name that may be served by the NRF associated with the associated information, and/or an identity of an NRF group that is served by the NRF associated with the associated information.

The NRF of FIG. 6B may transmit a discovery request to the registering network entity. The discovery request may request selection information for selecting at least one other NRF for supporting an NF. In response to this discovery request, the NRF may receive said selection information. The selection information may comprise associated information for the at least one other NRF.

The NRF of FIG. 6B may transmit a subscription request to the registering network entity. This subscription request may be for subscribing to being notified when selection information for selecting at least one other NRF changes at the registering network entity. In response to this subscription request, the NRF may receive a response indicating that the subscription has been set up successfully. A notification that said selection information has changed when said selection information changes may be received by the NRF at a later time. This notification may be sent using, for example, a HTTP Notification message. Although it is understood that other types of messaging protocols may be used, depending on the communication network configuration. The selection information may comprise associated information for the at least one other NRF.

The NRF of FIG. 6B may form an NRF group with at least one other NRF apparatus. In this case, when the NRF receives selection information for selecting said at least one other NRF, the NRF may determine that the at least one other NRF is part of the same NRF group and exchange information about network function instances served by the at least one other NRF. This exchanged information may be NrfInfo Profile Information Element described above, which comprises information of NF Instances that are currently registered to the at least one other NRF.

FIG. 6C illustrated signalling that may be performed by a network apparatus, such as an NRF and/or an NRF consumer. Contrary to the network apparatus of FIG. 6B, the presently described apparatus does not necessarily register with the registration entity, but does still interact with the registration entity.

At 601C, the network apparatus transmits a request to a registering network entity for associated information for selecting at least one Network Repository Function (NRF).

At 602C, the network apparatus receives said associated information in response to the request.

The associated information may describe the attributes of at least one network function that said NRF is intended to serve. For example, the associated information may be at least one of: an indication of at least one type of network function for which discovery queries are supported by the NRF associated with the associated information, an identification of at least one network slice served the NRF associated with the associated information, an identification of at least Public Land Mobile Network supported by the NRF associated with the associated information, an identification of at least one Fully Qualified Domain Name that may be served by the NRF associated with the associated information, and/or an identity of an NRF group that is served by the NRF associated with the associated information.

The network apparatus of FIG. 6C may transmit a discovery request to the registering network entity. The discovery request may request selection information for selecting at least one other NRF for supporting an NF. In response to this discovery request, the NRF may receive said selection information. The selection information may comprise associated information for the at least one other NRF.

The network apparatus of FIG. 6C may transmit a subscription request to the registering network entity. This subscription request may be for subscribing to being notified when selection information for selecting at least one other NRF changes at the registering network entity. In response to this subscription request, the NRF may receive a notification that said selection information has changed when said selection information changes. The selection information may comprise associated information for the at least one other NRF.

When the network apparatus of 6C is an NRF, the network apparatus may form an NRF group with at least one other NRF apparatus. In this case, when the NRF/network apparatus receives selection information for selecting said at least one other NRF, the NRF may determine that the at least one other NRF is part of the same NRF group and exchange information about network function instances served by the at least one other NRF. This exchanged information may be NrfInfo Profile Information Element described above, which comprises information of NF Instances that are currently registered to the at least one other NRF.

Therefore, in the above, there are provided NRFs that register themselves with a registration entity, such as with an NRF registrar. This may be performed by sending information to the registration entity in a registration request that indicates criterions that may be used to select this NRF. The registration may exclude information about the actual NF Instances currently registered in an NRF. In other words, the registration request may exclude NrfInfo as defined above.

As registrations are limited to being maintained by a registration entity, only an NRF registrar FQDN needs to be provisioned in NFs supporting this invention (i.e. so that the NRFs know which entity is the registration entity). The provisioned FQDN for registration may thus resolve to the IP/address of the registration entity. In other words, the provisioned FQDN may resolve to the registration entity bootstrap Uniform Resource Indicator. FQDN may be resolved via any of a number of different lookup mechanisms. For example, IPv6 defines an Authentication, Authorization, Accounting, and Auditing (AAAA) record that maps a hostname to a 128-bit IPv6 address in the Domain Name System (DNS) Internet Authentication Service. As another example, a Service Record (SRV) DNS query (SRV being defined in RFC 2782) may be used to lookup the address of the registration entity. An NRF/service consumer may perform lookup using a single mechanism. An NRF/service consumer may perform lookup using multiple mechanisms to provide redundancy.

That registering NRF (and/or other RNFs and service consumers), may send queries and/or requests to the registration entity (such as Discovery Queries and Subscribe requests) to learn about the Profiles of other NRFs in the network that are registered with the NRF registrar.

For example, with a Discovery Query, the registration entity may be asked to provide locally stored/maintained information that indicates criterions that may be used to select an NRF. A subscribe request may include a request to be notified when an NRF profile updates/changes and/or when new registering NRFs register with the NRF registrar. In response to receipt of a Discovery request, the registration entity may select an appropriate NRF based on at least one of a number of different features. For example, an NRF may be selected based on at least one of a locality, a priority, capacity, an SNSSAI, an FQDN, an NFType support, and/or supported features.

The registration entity may provide a requesting NRF with information in response to their query and/or request. NRFs may use at least part of the information provided by the registration entity in response to these queries and/or requests to decide to which NRF to route Discovery Queries for network function services that the requesting NRFs do not serve.

NRFs and NRF Consumers that do not support the presently described mechanism simply do not use the registration entity for requests and/or queries. Instead, they may send NRF service requests directly to locally provisioned NRFs, as described above.

The registration entity may be deployed as a high availability cluster. This means that there may be a group of NRF registrars that operate in parallel and share information. Any NRF registrar may be selected to acquire a service needed. Also, if any one of the NRF registrars in the group fails, at least one other NRF registrar in the group may be used to obtain the associated information. When the registration entity is comprised within an NRF registrar, the 5G core service operation may be assured even in case of total failure of the registration entity. This is because NRFs and NRF consumers retain the NRF topology meaning that NRF consumer requests can still be routed and served. Only procedures related to additions/removal/update of the NRF profiles are thus impacted by NRF Primary failure (e.g. an NRF cannot be added in the network until the NRF registrar is available again).

It is understood that although the present description focuses on the example of NRF and NRF service consumers discovering NRFs, that the presently described mechanisms may also apply to other network entities. For example, the presently described mechanisms may also be applied to equally apply to Service Communication Proxies (SCP) when, for example, an NF Service Consumer delegates the discovery of an NF service Producer to an SCP; in such a model, NF service consumers need not be changed, only the SCP needs to support the new procedures.

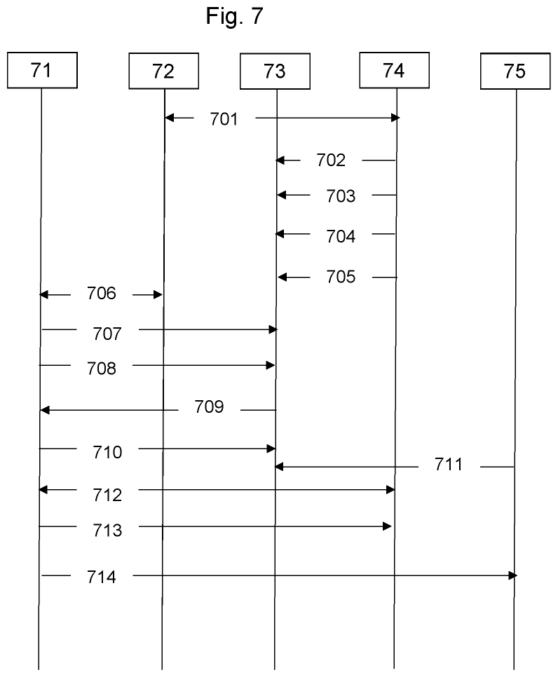

FIG. 7 illustrates an example signal flow between network entities in accordance with at least some of the presently described mechanisms. This, and the later flows, are illustrated using HTTP messages. However, it is understood that functional equivalents to this communication protocol may be used. Further, the following considers the NRF registration to be maintained by an NRF registrar. It is understood that the NRF registration may be maintained by a different network entity.

FIG. 7 shows potential signaling interactions between an NRF consumer 71, a domain name server (DNS) 72, an NRF registrar 73, a first NRF 74 and a second NRF 75. The first NRF 74 supports an AMF, an SMF and a Policy Charging Function. In contrast to the first NRF 74, instead of supporting an AMF, an SMF and a Policy Charging Function, the second NRF 75 supports an AUSF, a UDM and a UDR.

At 701, a first NRF 74 contacts DNS 72 to resolve an address for the NRF registrar 73

At 702, the first NRF 74 signals a Bootstrap message to the NRF registrar 73. In the present (and later) example, this bootstrap message may be in accordance with the a bootstrapping service defined in a communication protocol/specification. For example, chapter 5.5.1 of 3GPP TS 29.510 defines an Nnrf_Bootstrapping service for letting NF Service Consumers of the NRF know about the services endpoints it supports using a version-independent URI endpoint that does not need to be discovered by using a Discovery service. This is an example of one type of bootstrapping mechanism that may be applied.

At 703, the first NRF 74 signals a registration message to the NRF registrar 73. In the present (and later) example, a registration message is a message that causes a registration of an NRF in a register maintained by a receiving entity. This message may comprise information for selecting the first NRF (as described above). This information may comprise an AMF identification and/or an SMF identification. As an example, Section 5.2.2,1 of 3GPP TS 29.510 defines Nnrf_NFManagement Service for Registration.

At 704, the first NRF 74 signals a Discovery message to the NRF registrar 73. In the present (and later) example, a Discovery message is a message is used to discover other NRFs that are registered with the NRF registrar 73. The interface used for sending the Discovery message may be acquired from the bootstrap procedure. As an example, Section 5.3.2.1 of 3GPP TS 29.510 defines the Nnrf_NFDiscovery Service for Discovery.

At 705, the first NRF 74 signals a Subscribe message to the NRF registrar 73. In the present (and later) example, a subscribe message is a message used to subscribe to updates about changes to NRF profiles stored at the NRF registrar 73. The interface used for sending the Subscribe message may be acquired from the bootstrap procedure. As an example, Section 5.2.2,1 of 3GPP TS 29.510 defines Nnrf_NFManagement Service for subscribing (e.g. using NFListRetrieval).

At 706, the NRF consumer 71 contacts DNS 72 to resolve an address for the NRF registrar 73

At 707, the NRF consumer 71 signals a Bootstrap message to the NRF registrar 73.

At 708, the NRF consumer 71 signals a Discovery message to the NRF registrar 73. This message is used to discover other NRFs that are registered with the NRF registrar 73. The interface used for sending the Discovery message may be acquired from the bootstrap procedure.

At 709, the NRF registrar 73 responds to the message sent at 708 with information providing selection information for at least one NRF. This information may comprise an AMF identification and/or an SMF identification. By way of example, this information may correspond to a first NRF, labelled NRF1.

At 709, the first NRF 74 signals a Subscribe message to the NRF registrar 73. This message is used to subscribe to updates about changes to NRF profiles stored at the NRF registrar 73.

At 710, the Second NRF 75 signals a Register message to the NRF registrar 73. This message may comprise information for selecting an NRF (as described above). This information may comprise an AMF identification and/or an SMF identification. By way of example, this information may correspond to a second NRF, labelled NRF2.

In response to this registration message, at 711 the NRF registrar may signal updates to both the first NRF 74 and the NRF consumer 71. This update may be conveyed using POST: notify procedures. This update may comprise selection information for NRF2. The selection information may comprise information about a UDM and AUSF associated with NRF2.

At 712, the service consumer 71 signals a GET: SMF request to the first NRF 74 to obtain a SMF for NRF1.

At 713 the service consumer 71 signals a GET: SMF request to the second NRF 75 to obtain a UDM for NRF2.

In other words, at 712 and 713, the NRF service consumer 71 may use the provided information to select an appropriate NRF for each query to be made by that NRF service consumer.

Therefore, in the above, when an NRF is added in the network the NRF registers itself to the NRF registrar and retrieves Profile information of the other NRFs and/or Subscribes for updates regarding the Profile information of the other NRFs.

In contrast to the current in which NRFs share information about the actual NF Instances that are currently registered to this NRF (labelled as NRFInfo in current specifications), the presently described NRFs register information that describes the attributes of NFs this NRF is intended to serve. This may be labelled as, for example, NRFSelectionInfo.

Consequently, the NRF registrar, and the NRFs that have subscribed to the NRF registrar do not need to be informed about updates in the NRFInfo Profile (which are frequent), but may instead be informed in case of changes in the NRFSelectionInfo (which are much less frequent).

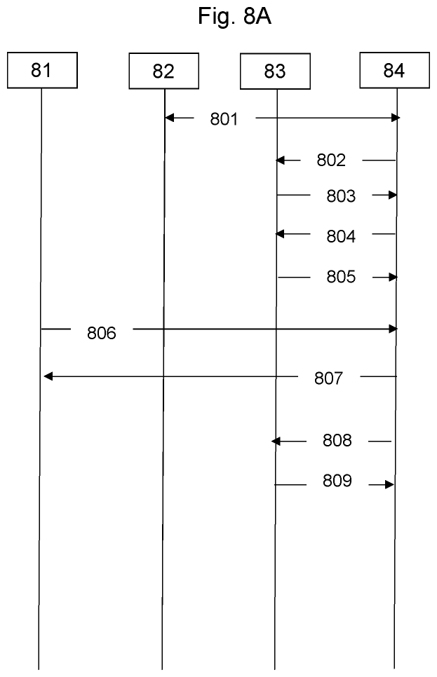

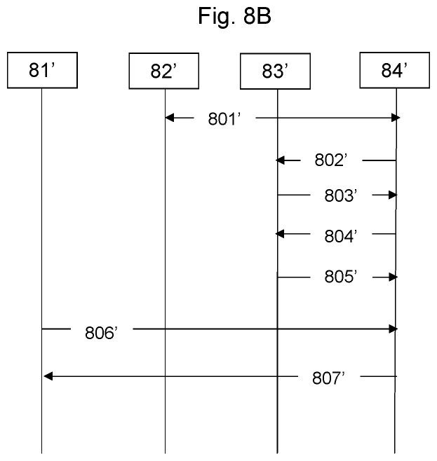

FIGS. 8A and 8B illustrate signal flows to contrast previous signalling procedures compared to the presently described procedure.

FIG. 8A relates to signalling performed between an NRF consumer 81, a DNS 82, a first NRF 83 and a second NRF 84.

At 801, the second NRF 84 obtains from DNS 82 an address for a local master NRF (which turns out to be the first NRF 83 in the present case).

At 802, the second NRF 84 sends a Bootstrap message to the first NRF 83.

At 803, the first NRF 83 responds to the message of 802 with an OK message.

At 804, the second NRF 84 sends a Register message to the first NRF 83. This Register message comprises information on multiple NFs served by the second NRF 84. For example, this message may comprise NRFInfo.

At 805, the first NRF 83 responds to the message of 804 with an OK message.

At 806, NRF service consumer 81 sends a Register information to the second NRF with information comprising new profile information for an NF.

At 807, the second NRF 84 responds to the message of 806 with an OK message.

At 808, the second NRF 84 send an NFupdate message to the first NRF 83 that comprises the new profile information of 806.

At 809, the first NRF 83 responds to the message of 808 with an OK message.

FIG. 8B shows potential signaling that may be exchanged in accordance with at least some of the presently described mechanisms.

FIG. 8B relates to signalling performed between an NRF consumer 81′, a DNS 82′, an NRF registrar 83′ and a first NRF 84′.

At 801′, the first NRF 84′ obtains from DNS 82′ an address for primary NRF 83′.

At 802′, the first NRF 84′ sends a Bootstrap message to the NRF registrar 83′.

At 803, the NRF registrar 83′ responds to the message of 802′ with an OK message.

At 804′, the first NRF 84′ sends a Register message to the NRF registrar 83′. This Register message comprises information for NRFselection. This message does not comprise NRFinfo.

At 805′, the NRF registrar 83′ responds to the message of 804′ with an OK message.

At 806′, the NRF service consumer 81′ sends a Register information to the first NRF 84 with information comprising new profile information for an NF.

At 807′, the first NRF 84′ responds to the message of 806′ with an OK message. However, as only the NRFprofile information for the first NRF 84′ has changed while the selection criteria remains unchanged, the first NRF 84′ does not transmit any update to the NRF registrar 83′.

The already existing NRFs in the network may be informed by the NRF registrar whenever a new NRF is added in the network. However, in contrary to the current practice of sharing NRFInfo, only the NRFSelectionInfo of the NRF profile is shared with all the other NRF elements.

Moreover, it may be that only NRFs belonging to the same Group (which may be indicated via the groupId in the NRFSelectionInfo) will additionally exchange NrfInfo and possibly Subscribe for updates and acquire the full profiles via the NFListRetrieval procedure. An NRF may be assigned an NRF group ID by and Operations and Management Function in the network.

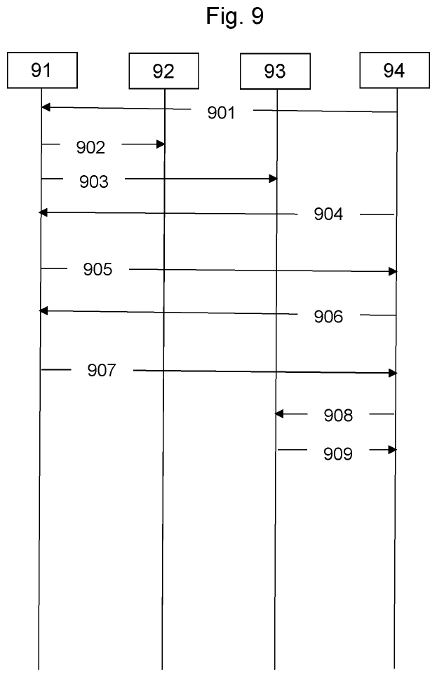

FIG. 9 is a signalling diagram illustrating a potential NRF Registration procedure.

FIG. 9 illustrates signalling between an NRF registrar 91, a first NRF 92, a second NRF 93 and a third NRF 93. It is assumed that the second and third NRFs are members of the same NRF group while the first NRF 91 is not a member of this group. Further, it is assumed that the first and second NRFs are already registered with the NRF registrar 91 whilst the third NRF 94 is new to the network.

At 901, the third NRF 94 signals a Register request to the NRF registrar 91. This request comprises NRFSelectionInfo for the third NRF 94.

At 902, the NRF registrar 91 signals a Notify message to the first NRF 92. This message may comprise the NRFSelectionInfo for the third NRF 94.

At 903, the NRF registrar 91 signals a Notify message to the second NRF 93. This message may comprise the NRFSelectionInfo for the third NRF 94.

At 904, the third NRF 94 may signal the NRF registrar 91 with a request for selection information for all registered NRFs at the NRF registrar 91. This may be performed, for example, using a GET message.

At 905, the NRF registrar 91 provides the third NRF 94 with NRFSelectionInfo for the first NRF 92 and NRFSelectionInfo for the second NRF 93.

At 906, the third NRF 94 may signal a Subscribe message to the NRF registrar for any information relating to updates to the NRF selection information stored at the NRF registrar 91.

At 907, the NRF registrar 91 responds to the message of 906 with an OK message.

At 908, the third NRF 94 sends a request to its group member, the second NRF 93, for the NRFinfo of the second NRF 93.

At 909, the second NRF 93 responds to the message of 908 with the NRFinfo of the second NRF 93.

At 910, the second NRF 93 sends a request to its group member, the third NRF 94, for the NRFinfo of the third NRF 94.

At 911, the third NRF 94 responds to the message of 910 with the NRFinfo of the third NRF 94.

At 912, the second and third NRFs may send each other messages for subscribing to changes in the provided NRFinfo of 909 and 911, and/or sending messages for retrieving a list of all NF instances currently registered at the second and third NRFs.

As discussed above, NRF service consumers may also discover and select NRFs via the NRF registrar. Although the NRF service consumers do not register to the NRF registrar, they may contact the NRF registrar to acquire NRFSelectionInfo Profile information of the available NRFs and Subscribe for updates. The NRF service consumers may then use this provided information from the NRF registrar to discover appropriate NRFs to Register and to route Discovery queries to without having to locally provision that information.

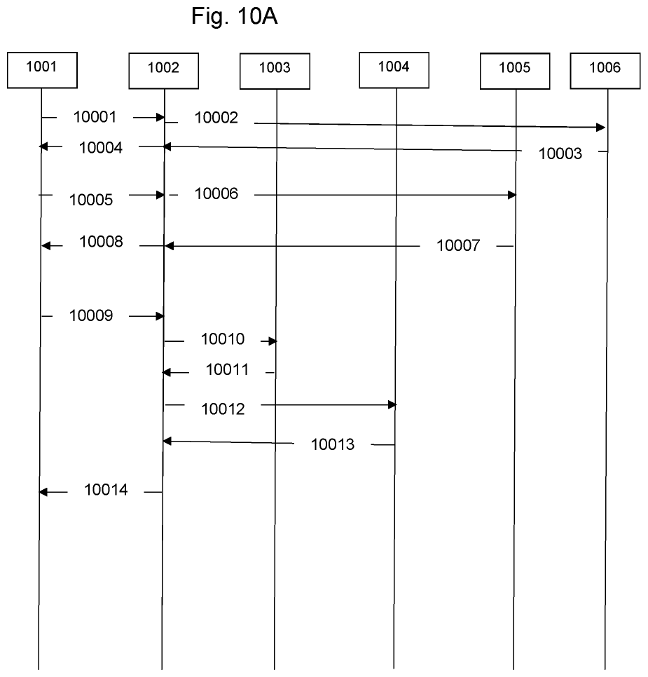

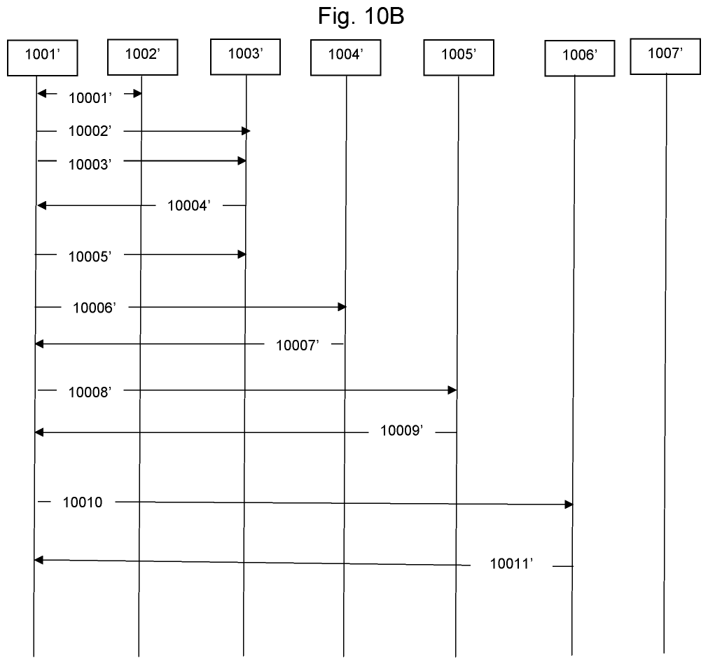

FIGS. 10A and 10B illustrate potential differences between current systems and the presently described mechanisms.

FIG. 10A presents example signaling in accordance with current specifications.

FIG. 10A illustrates signaling between an NRF consumer 1001, a first NRF 1002, a second NRF 1003 (serving locally as a local master NRF), a third NRF 1004, a fourth NRF 1005 and a fifth NRF 1006.

At 10001, the NRF consumer 1001 sends a GET: UDM message to the first NRF 1002.

At 10002, in response to the message of 10001 the first NRF 1002 sends a GET: UDM message to the fifth NRF 1006.

At 10003, in response to the message of 10002 the fifth NRF 1006 sends an OK message to the first NRF 1002.

At 10004, in response to the message of 10003 the first NRF 1002 sends an OK message to the NRF consumer 1001 that comprises the requested UDM information.

At 10005, the NRF consumer 1001 sends a GET: PCF message to the first NRF 1002.

At 10006, when the first NRF 1002 does not have the requested PCF information stored locally, in response to the message of 10005 the first NRF 1002 sends a GET: PCF message to the fourth NRF 1005.

At 10007, in response to the message of 10006 the fourth NRF 1005 sends an OK message to the first NRF 1002.

At 10008, in response to the message of 10007 the first NRF 1002 sends an OK message to the NRF consumer 1001 that comprises the requested PCF information.

At 10009, the NRF consumer 1001 sends a GET: EIR message to the first NRF 1002 to obtain and/or check an equipment identity.

At 10010, when the first NRF 1002 does not have the requested (Equipment Identity Register (EIR) information stored locally, in response to the message of 10009 the first NRF 1002 sends a GET: EIR message to the second (master) NRF 1003.

At 10011, in response to the message of 10010 the second NRF 1003 sends an OK message to the first NRF 1002.

At 10012, when the second NRF 1003 did not return the requested EIR information in 10012, the first NRF 1002 sends a GET: EIR message to the third NRF 1004.

At 10013, in response to the message of 10012 the second NRF 1003 sends an OK message to the first NRF 1002 that comprises the requested EIR.

At 10014, the first NRF 1002 sends an OK message to the NRF consumer 1001 that comprises the requested EIR.

FIG. 10B shows example signaling in accordance with the presently described techniques.

FIG. 10B illustrates signaling between an NRF consumer 1001′, a DNS 1002′, an NRF registrar 1003′, a first NRF 1004′, a second NRF 1005′, a third NRF 1006′, and a fourth NRF 1007′. In this example, the first NRF 1004′ and the second NRF 1005′ are considered to be part of the same NRF group, and the third NRF 1006′ and the fourth NRF 1007′ are considered to be part of the same NRF group (different to thr group of the first and second NRFs).

At 10001′, the NRF consumer 1001′ exchanges signaling with the DNS 1002′ to resolve an address of the NRF registrar 1003′.

At 10002′, the NRF consumer 1001′ signals a Bootstrap message to the NRF registrar 1003′.

At 10003′, the NRF consumer 1001′ signals a Discovery NRFs message to the NRF registrar 1003′.

At 10004′, the NRF registrar 1003′ returns and OK message to the NRF consumer 1001′ that comprises NRFSelectionInfo for at least one NRF. The provided selection information may be limited based on the information comprised within the NRF profile information stored at the NRF 1003′.

At 10005′, the NRF consumer 1001′ signals a Subscribe message to the NRF registrar 1003′ to subscribe to changes in the NRFSelectionInfo.

At 10006′, the NRF consumer 1001′ sends a GET: UDM1 request for information regarding a first UDM to the first NRF 1004′.

At 10007′, the first NRF 1004′ responds to the message of 10006′ with an OK message (and potentially with information regarding the first UDM).

At 10008′, the NRF consumer 1001′ sends a GET: UDM2 request for information regarding a second UDM to the second NRF 1005′.

At 10009′, the second NRF 1005′ responds to the message of 10008′ with an OK message (and potentially with information regarding the second UDM).

At 10010′, the NRF consumer 1001′ sends a GET: PCF request for information regarding a PCF to the third NRF 1006′.

At 10011′, the third NRF 1006′ responds to the message of 10010′ with an OK message (and potentially with information regarding the PCF).

In order to accommodate communication of the presently defined NRFSelectionInfo, the NFProfile Information defined in 3GPP TS 29.510 may be extended to support an NRFSelectionInfo Information element (IE). For example, the NFProtile Information may comprise a unique identity of an NF instance (NfInstanceID), an indication of a type of network function (nfType), a status of the NF instance (nfStatus), a human readable name of the NF instance (nfInstanceName), specific data for the NRF (nrfinfo) and the presently described IE that comprises specific data for NRF selection (Nrfselection).

The following tables provide an example definition of the NRFSelectionInfo Information element. However, it is understood that different names or selection attributes could accordingly be defined. In case this IE is not standardized custom vendor, specific IEs can be used for the same purpose however due to the proprietary manner the solution/benefits are restricted only to NFs supporting the specific customization.

TABLE 1

| Attribute name | Data type | P | Cardinality | Description |
|---|---|---|---|---|
| Groupid | NFGroupId | O | 0 . . . 1 | Identity of the NRF group |
| | | | | that is served by the NRF |
| | | | | instance. If not provided, |
| | | | | the NRF instance may be |
| | | | | assumed to not pertain to |
| | | | | any NRF group. |
| supportedNfType | Array (NFType) | O | 1 . . . N | NF Types for which |
| | | | | Discovery Queries are |
| | | | | supported (target-nf-type). |
| | | | | If empty, it is assumed that |
| | | | | all NF types are supported. |
| Snssais | Array(Snssais) | O | 1 . . . N | List of supported single |
| | | | | slices (Snssais). If empty, |
| | | | | all Snssais are supported. |
| Plmn | Array(Plmn) | O | 1 . . . N | Last of supported target |
| | | | | PLMNs (target-plmn-list). |
| | | | | If empty, all PLMNs are |
| | | | | supported. |
| fqdnList | Array(fqdnList) | O | 1 . . . N | The list of FQDNs the NRF |
| | | | | can support (target-nf- |
| | | | | fqdn). If empty, all FQDNs |
| | | | | are supported. |

Elements of the above-described signalling procedures may be considered to have several different advantages over current systems.

For example, due to the automation provided by the new signalling mechanisms, new NRFs to a communication system may be immediately used by NRF consumers without any local provisioning,

Further, the presently described signalling may be considered to have Improved Load/Overload control. In particular, Load balancing and Overload mechanisms defined in an operating communication protocol, such as defined in 3GPP TS 29.500 and 3GPP TS 29.510, may be reused for load balancing traffic towards NRFs.

Further, the presently described signalling may be considered to have an improved Signalling Efficiency, as NF consumers can route Discovery Queries directly to the “correct” NRF group, which avoids NRF Message forwarding.

Further, the presently described signalling may be considered to provide improved scalability over current systems as NF Information can be organized in smaller clusters. This is because the NRF registrar does not need to store the NrfInfo, but only the NrfSelectionInfo

Further, the presently described signalling may be considered to have an improved flexibility over current systems as multiple criterions can be used for NRF selection, and they are not limited to Slice Specific NRF selection.

Finally, the presently described systems may be introduced in a stepwise implementation and deployment without service interruption. For example, in an initial phase, the NRF registrar may be used for inter-NRF discovery. Later phases may introduce the use of the NRF registrar by SCPs and certain NRF consumers. The other consumers may still select NRFs based on local provisioning. In that case, all NFs will have access to the NRF services while the presently described benefits will be leveraged only by the subset of the NFs that support the presently described signalling techniques.

Although the following focuses on the discovery of an NRF itself, it is understood that similar techniques may be applied for discovery of at least one entity within the NRF. For example, FIG. 5 shows an NRF 501 that comprises a System Information Retrieval Function (SIRF) 502. The SIRF has a similar role for Lawful Interception as it is responsible for providing the Lawful Interception Provisioning Function (LIPF) 503 for NFs that are known by the SIRF (e.g. service topology). For example, the SIRF is responsible for providing the LIPF and/or the Lawful Interception Control Function (LICF) with the system related information for NFs that are known by the SIRF (e.g. service topology). The information provided by the SIRF allows the LIPF/LICF to perform operations for establishing and maintaining interception of the target service.

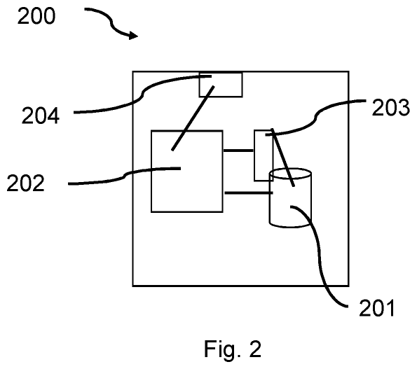

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example the control apparatus 200 or processor 201 can be configured to execute an appropriate software code to provide the control functions.

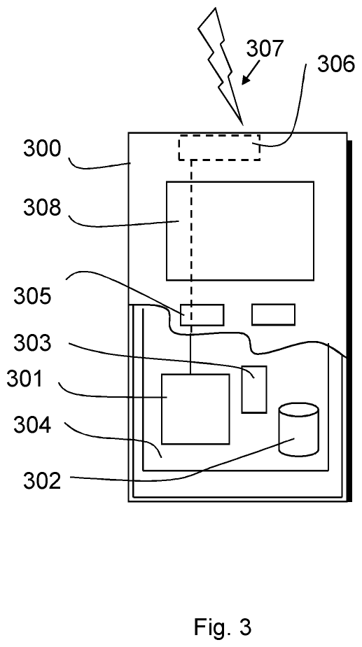

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 704. The user may control the operation of the wireless device by means of a suitable user interface such as key pad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

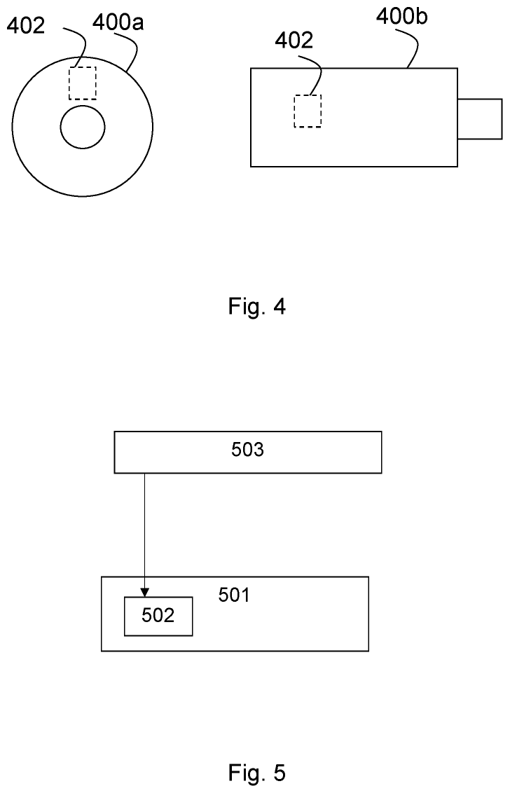

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIGS. 6A to 6C.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 6A to 6C, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1-21. (canceled)

22. A network apparatus, comprising:
at least one processor; and
at least one memory including computer program code, the at least one memory and computer program code configured to, with the at least one processor, cause the apparatus at least to:
maintain a registration of at least one Network Repository Function (NRF) with respective associated information for selecting the at least one NRF; and
provide, in response to a request for NRF information from a requesting network entity, the associated information to the requesting network entity.

23. A network apparatus as claimed in claim 22, wherein the at least one processor and the at least one memory including the computer program code are further configured to cause the apparatus to: receive a registration request from the at least one NRF, the registration request comprising the associated information.

24. A network apparatus as claimed in claim 22, wherein the request for NRF information is a Discovery request, and wherein the at least one processor and the at least one memory including the computer program code are further configured to cause the apparatus to: select a subset of the total associated information maintained at the network apparatus and provide the subset of the total associated information in said response.

25. A network apparatus as claimed in claim 22, wherein said request for NRF information is a subscription request, and wherein said response is sent when there is change in said registration of the at least one NRF.

26. A network apparatus as claimed in claim 22, wherein the network apparatus is comprised within an NRF.

27. A network apparatus as claimed in claim 22, wherein the at least one processor and the at least one memory including the computer program code are further configured to cause the apparatus to: provide the associated information to other NRFs.

28. A network apparatus for a Network Repository Function (NRF), comprising:
at least one processor; and
at least one memory including computer program code, the at least one memory and computer program code configured to, with the at least one processor, cause the apparatus at least to: transmit a registration request to a registering network entity, wherein the registration request comprises associated information for selecting the NRF.

29. A network apparatus as claimed in claim 28, wherein the at least one processor and the at least one memory including the computer program code are further configured to cause the apparatus to:
transmit a discovery request to the registering network entity for selection information for selecting at least one other NRF; and
receive said selection information in response to the discovery request.

30. A network apparatus as claimed in claim 28, wherein the at least one processor and the at least one memory including the computer program code are further configured to cause the apparatus to:
transmit a subscription request to the registering network entity for subscribing to being notified when selection information for selecting at least one other NRF changes at the registering network entity; and
receive a notification that said selection information has changed in response to the subscription request.

31. A network apparatus as claimed in claim 28, wherein network apparatus forms an NRF group with at least one other NRF apparatus, and wherein the at least one processor and the at least one memory including the computer program code are further configured to cause the apparatus to:
receive selection information for selecting said at least one other NRF;
determine that said at least one other NRF is part of the same NRF group; and
exchange information about network function instances served by the at least one other NRF and the network apparatus in response to said determining.

32. A network apparatus comprising:
at least one processor; and
at least one memory including computer program code, the at least one memory and computer program code configured to, with the at least one processor, cause the apparatus at least to:
transmit a request to a registering network entity for selection information for selecting at least one Network Repository Function (NRF); and
receive said selection information in response to the request.

33. A network apparatus as claimed in claim 32, wherein the request is a discovery request.

34. A network apparatus as claimed in claim 32, wherein the associated information for a particular NRF describes the attributes of at least one network function that said particular NRF is intended to serve.

35. A network apparatus as claimed in claim 34, wherein the associated information comprises at least one of: an indication of a location of an entity to which a service is to be provided, an indication of a serving area, an indication of at least one type of network function for which discovery queries are supported by the NRF associated with the associated information, an identification of at least one network slice served the NRF associated with the associated information, and/or an identification of at least Public Land Mobile Network supported by the NRF associated with the associated information, an identification of at least one Fully Qualified Domain Name that may be served by the NRF associated with the associated information.

36. A network apparatus as claimed in claim 35, wherein the associated information comprises an identity of an NRF group that is served by the NRF associated with the associated information.

37. A network apparatus as claimed in claim 34, wherein the associated information comprises an identity of an NRF group that is served by the NRF associated with the associated information.
